(19) United States
(12) Patent Application Publication
(10) Pub. No.: US 2025/0257844 A1
(43) Pub. Date: Aug. 14, 2025

(54) SYSTEM AND METHOD FOR REMOTE NON-CONTACT CALIBRATION OF ROADSIDE SENSORS

(71) Applicant: Black Sesame Technologies Inc., San Jose, CA (US)

(72) Inventors: Jizhang Shan, Los Gatos, CA (US); Qun Gu, San Jose, CA (US); Mingrui Qi, San Jose, CA (US); Yecheng Lyu, Santa Clara, CA (US); Lei Zhang, Santa Clara, CA (US)

(73) Assignee: Black Sesame Technologies Inc., San Jose, CA (US)

(21) Appl. No.: 18/440,714

(22) Filed: Feb. 13, 2024

(51) Int. Cl. F17C 3/00

(52) U.S. Cl. CPC F17C 3/00; F17C 2201/0166; F17C 2203/0631; F17C 2203/0639; F17C 2203/066; F17C 2270/02

(57) ABSTRACT

Embodiments of this disclosure can provide a system and method for calibrating extrinsic parameters of roadside sensors for autonomous driving. During operation, a portable light-detection-and-ranging (lidar) unit can be brought to a sensor-installation site comprising one or more to-be-calibrated roadside sensors, and the portable lidar unit can scan outer surfaces of the to-be-calibrated roadside sensors from different angles to generate a stream of frames. The system can align, spatially, the stream of frames based on a local reference coordinate system, superimpose the aligned frames, and segment a point cloud associated with a to-be-calibrated roadside sensor. The system can determine extrinsic parameters of the to-be-calibrated roadside sensor with respect to the local reference coordinate system based on the segmented point cloud and convert the extrinsic parameters from the local reference coordinate system to a road-based coordinate system.

### BACKGROUND

### Field

The disclosed embodiments generally relate to autonomous driving. More specifically, the disclosed embodiments relate to efficient and non-contact calibration of roadside sensors.

### Related Art

The success of autonomous driving depends largely on a vehicle's ability to collect and process massive traffic states, including its states (e.g., direction and speed) and the states of other objects surrounding the vehicle. The dynamic nature of the spatial-temporal characteristics of the traffic states and the constrained perception range of the vehicle often hinder the vehicle's ability to collect state information about traffic scenes. Moreover, on-vehicle sensors can have their limitations (e.g., being occluded).

Roadside sensors have been used to extend the data collection ability of on-vehicle sensors. For example, sensors mounted on roadside traffic structures (e.g., light posts or traffic lights) often have an unobstructed view of the road and can be more effective in collecting traffic states. Various multi-sensor fusion strategies have been proposed to combine data collected by roadside sensors with data collected by on-vehicle sensors. Because raw sensor data are typically based on the coordinate systems respective of the individual sensors, combining or fusing data from different sensors requires a transformation of raw sensor data into a unified coordinate system. Moreover, processing and analyzing the sensor data for autonomous driving purposes are often centered around the road. Therefore, it is important to transform all raw sensor data from their respective sensor-based coordinate systems to the road-based coordinate system. Traditional calibration methods used to establish mappings between sensor-based coordinate systems and the road-based coordinate system are often inadequate for autonomous driving applications that deploy a large number of roadside sensors.

### SUMMARY

Embodiments of this disclosure can provide a system and method for calibrating extrinsic parameters of roadside sensors for autonomous driving. During operation, a portable light-detection-and-ranging (lidar) unit can be brought to a sensor-installation site comprising one or more to-be-calibrated roadside sensors, and the portable lidar unit can scan outer surfaces of the to-be-calibrated roadside sensors from different angles to generate a stream of frames. The system can align, spatially, the stream of frames based on a local reference coordinate system, superimpose the aligned frames, and segment, from the superimposed frames, a point cloud associated with a to-be-calibrated roadside sensor. The system can determine extrinsic parameters of the to-be-calibrated roadside sensor with respect to the local reference coordinate system based on the segmented point cloud and then convert the extrinsic parameters from the local reference coordinate system to a road-based coordinate system.

In a variation on this embodiment, aligning the stream of frames can include applying an Iterative Closest Point (ICP) algorithm.

In a variation on this embodiment, the portable lidar unit can further include one or more position sensors. Aligning the stream of frames can include determining an instant pose of the portable lidar unit associated with each frame of the stream of frames based on measurements of the position sensors.

In a further variation, the local reference coordinate system can be determined based on the instant pose of the portable lidar unit associated with a first frame of the stream of frames.

In a further variation, the position sensors comprise one or more of: a Global Positioning System (GPS) sensor; an Inertial Measurement Unit (IMU); and a rotary encoder.

In a variation on this embodiment, the system can determine a transformation matrix between the local reference coordinate system and the road-based coordinate system.

In a further variation, converting the extrinsic parameters from the local reference coordinate system to the road-based coordinate system comprises multiplying the extrinsic parameters with the transformation matrix.

In a variation on this embodiment, the portable lidar unit can be configured to scan, in each frame, at least two reference objects with distinctive features, and aligning, spatially, the stream of frames can include aligning the reference objects.

In a variation on this embodiment, determining the extrinsic parameters of the to-be-calibrated roadside sensor can include comparing the segmented point cloud with a computer-aided design (CAD) model of the roadside sensor or a point cloud of the roadside sensor obtained by scanning the roadside sensor prior to installation.

In a variation on this embodiment, aligning, spatially, the stream of frames can include removing transitory objects from each frame.

### DESCRIPTION OF THE FIGURES

FIG. 1 illustrates an exemplary multi-sensor data-collection system, according to one embodiment of the instant application.

FIG. 2 illustrates an exemplary scenario for calibrating a roadside sensor, according to one embodiment of the instant application.

FIG. 3 illustrates an exemplary scenario for calibrating multiple roadside sensors, according to one embodiment of the instant application.

FIG. 4 illustrates an exemplary block diagram of a sensor-calibration system, according to one embodiment of the instant application.

FIG. 5 presents a flowchart illustrating an exemplary sensor-calibration process, according to one embodiment of the instant application.

FIG. 6 illustrates an exemplary computer system that facilitates the sensor calibration operation, according to one embodiment of the instant application.

In the figures, like reference numerals refer to the same figure elements.

### DETAILED DESCRIPTION

The following description is presented to enable any person skilled in the art to make and use the disclosed embodiments and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

### Overview

Embodiments of this disclosure provide a system and method for determining poses (i.e., the extrinsic parameters) of roadside sensors using a non-contact technique. To facilitate the efficient and accurate calibration of roadside sensors, a sensor-calibration system can include a portable light detection and ranging (lidar) unit (or lidar for short) that can scan the exterior of roadside sensors to obtain multiple lidar frames. The multiple lidar frames can be aligned in the spatial domain and superimposed to obtain a high-precision three-dimensional (3D) point cloud of each to-be-calibrated roadside sensor. The pose (or extrinsic parameters) of a roadside sensor in a lidar-based coordinate system can then be determined based on known dimensions of the roadside sensor. Given that the pose of the lidar in the road-based coordinate system is known, a transformation matrix between the lidar-based coordinate system and the road-based coordinate system can be derived. Accordingly, the previously obtained extrinsic parameters of the roadside sensor can be converted from the lidar-based coordinate system and the road-based coordinate system, thus facilitating the calibration of the roadside sensor. Once the extrinsic parameters of a roadside sensor are calibrated, raw sensor data collected by the roadside sensor can be converted to the road-based coordinate system.

### Roadside-Sensor Calibration

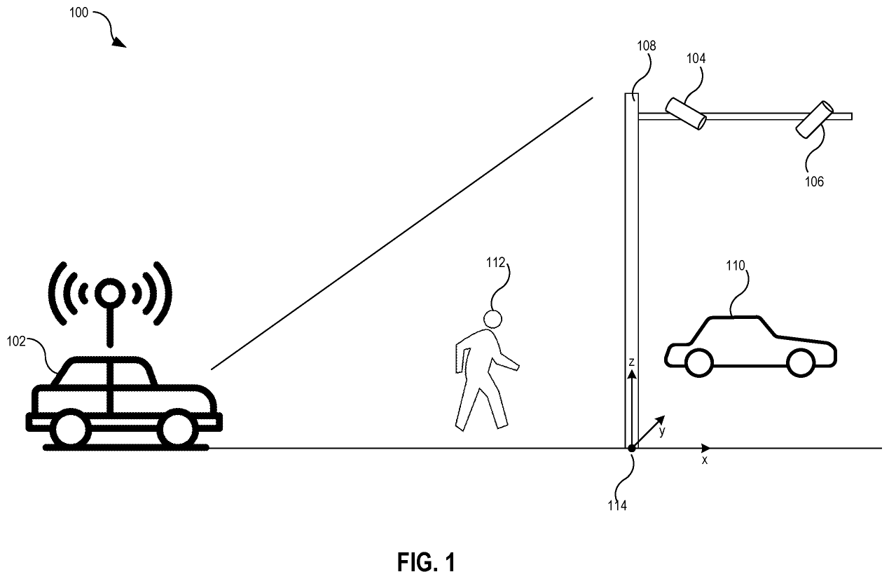

FIG. 1 illustrates an exemplary multi-sensor data-collection system, according to one embodiment of the instant application. In FIG. 1, a multi-sensor data-collection system 100 can include a vehicle 102 driving on a road and roadside sensors 104 and 106 mounted on a permanent traffic structure 108.

Vehicle 102 can be equipped with various types of sensors, such as visible-light cameras, infrared cameras, radars, lidar units, Global Positioning System (GPS) sensors, Inertial Measurement Unit (IMU) modules, sound sensors, etc. Roadside sensors 104 and 106 can include similar types of sensors.

Each sensor, regardless of an on-vehicle or roadside sensor, can collect data (e.g., traffic states) regarding its surroundings, which can include another vehicle 110 and a pedestrian 112. The raw sensor data are inherently expressed in the coordinate system centered at the corresponding sensor. For example, data collected by a sensor (e.g., a camera or a lidar unit) on vehicle 102 can be expressed in the vehicle coordinate system, the origin of which can be anchored to a fixed point on vehicle 102. On the other hand, data collected by roadside sensor 104 or 106 can be represented in a corresponding roadside-sensor-based coordinate system anchored to sensor 104 or 106, respectively.

Combining data from the various sensors requires that raw sensor data captured by the different sensors be represented using the same coordinate system. Because various tasks involved in autonomous driving (e.g., path planning, localization, mapping, obstacle detection, etc.) often require analyzing data in the road-based coordinate system (e.g., coordinate system 114 shown in FIG. 1), it makes sense to convert raw sensor data from different sensors from their respective sensor-based coordinate systems to the road-based coordinate system. In the example shown in FIG. 1, the origin of road-based coordinate system 114 can be placed at the base of traffic structure 108, with the x-axis being along the direction of the road, the y-axis being perpendicular to the road, and the z-axis being the vertical axis. There can be other ways to define the road-based coordinate system.

The conversion of the raw roadside sensor data from the roadside-sensor-based coordinate system to the road-based coordinate system requires the knowledge of the extrinsic parameters of the roadside sensor that define the pose (position and orientation) of the sensor. The process for determining such extrinsic parameters can be referred to as calibration.

Some existing calibration techniques often rely on using instruments, such as real-time kinematic positioning (RTK) GPS, to measure the installation positions/orientations of roadside sensors (e.g., cameras, lidars, or millimeter-wave radars). Such approaches require expensive survey-grade equipment and can only determine the position/orientation of one sensor at a time. The measurement process can be time-consuming and may sometimes require temporary road closures. Certain calibration approaches also require high-elevation construction lifts, meaning that additional measures must be taken to ensure the safety of the measurement personnel. Some other existing calibration methods may rely on additional data (e.g., high-resolution maps) and auxiliary equipment (e.g., calibration boards, calibration target vehicles with RTK GPS, drones that can capture images, etc.) to perform joint calibration, which cannot be applied to non-camera sensors (e.g., thermal cameras, radars, lidars, etc.) and cameras with nonpublic data. Moreover, existing approaches are generally not suitable for calibrating a large number of sensors.

To overcome the shortcomings of existing calibration approaches, some embodiments of the instant application provide a system and method that can calibrate roadside sensors in an efficient and non-contact manner, making it an ideal candidate for autonomous driving applications.

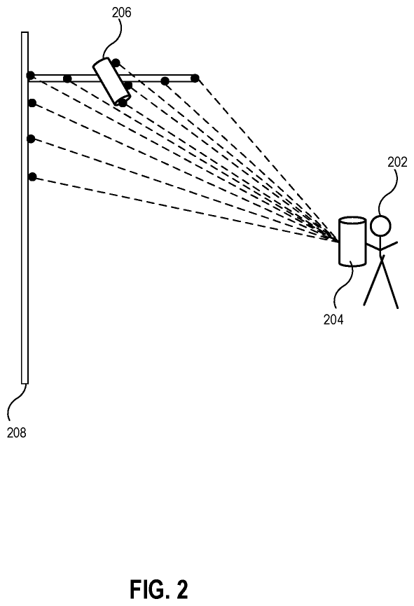

FIG. 2 illustrates an exemplary scenario for calibrating a roadside sensor, according to one embodiment of the instant application. In FIG. 2, a user 202 carrying a portable lidar unit 204 is approaching a roadside sensor 206 mounted on a permanent traffic structure (e.g., a light post) 208. User 202 can use portable lidar unit 204 to perform a continuous scan of the scene that comprises roadside sensor 206 and its surroundings. For example, user 202 can aim portable lidar unit 204 at roadside sensor 206 and manipulate it in a way such that the laser beam of portable lidar unit 204 can repeatedly sweep over the exterior (e.g., the outer shell) of road sensor 206 (e.g., from left to right or from top to bottom). To increase the calibration accuracy, one should make sure that the laser beam can scan as much surface as possible to achieve a high-density 3D point cloud. In one example, portable lidar unit 204 can generate a stream of lidar frames comprising at least ten lidar frames, with each frame containing a point cloud corresponding to roadside sensor 206.

In some embodiments, to achieve a high-density point cloud for roadside sensor 206, one can superimpose multiple lidar frames, with each frame comprising a point cloud of roadside sensor 206. However, the pose of portable lidar unit 204 changes as it scans the surface of roadside sensor 206, meaning that the lidar frames are generated based on different coordinate systems, and the point clouds in different lidar frames are misaligned spatially. More specifically, each lidar frame can be generated based on the instant lidar-based coordinate system (i.e., the distance vectors are defined with respect to the instant lidar-based coordinate system). Before the lidar frames can be superimposed, they should be aligned in the spatial domain. In some embodiments, aligning the lidar frames in the spatial domain can include converting all lidar frames to the same coordinate system.

Various techniques can be used to align the lidar frames defined under different coordinate systems. In some embodiments, lidar frames, including the point clouds in the lidar frames, can be aligned using an iterative closest point (ICP) algorithm. To ensure the alignment accuracy, in some embodiments, each lidar frame captured by portable lidar unit 204 should include multiple reference objects. Each reference object can have a distinct easy-to-recognize feature. Large cylindrical objects (e.g., utility poles or light posts) are good examples of reference objects. Moreover, each lidar frame can also include the ground as a reference plane. For example, two lidar frames can be aligned by aligning the reference objects and ground in one frame with the corresponding reference objects and ground in another frame.

In alternative embodiments, a local reference coordinate system can be determined, and all lidar frames captured by portable lidar unit 204 can be converted to the local reference coordinate system. The local reference coordinate system can be determined arbitrarily. In one example, the local reference coordinate system can be chosen as the lidar-based coordinate system corresponding to the first frame in the stream of frames. In other words, the local reference coordinate system can be determined based on the instant pose of portable lidar unit 204 when it captures the first lidar frame. For example, the origin of the local reference coordinate system can be the location of a predetermined point on portable lidar unit 204 at that time instant, and an axis of the local reference coordinate system can be in the direction the optical axis of portable lidar unit 204 at that time instant. In some embodiments, portable lidar unit 204 can include a number of built-in location sensors, including but not limited to an RTK GPS, an IMU, a rotary encoder, etc. In such a scenario, the lidar frames can be aligned based on sensor data from the various location sensors. For example, the instant pose of portable lidar unit 204 at a given time instant with respect to the local reference coordinate system can be determined based on the location sensor data, and the corresponding frame captured at the given time instant can then be converted to the local reference coordinate system based on the instant pose.

After the lidar frames or point clouds have been converted to the local reference coordinate system, they can be superimposed onto each other to create a high-density point cloud of the scene. The number of data points on a particular surface of roadside sensor 206 can increase when lidar frames captured from different angles are superimposed.

A segmentation operation can be performed on the aligned and superimposed lidar frames to distinguish a point cloud of roadside sensor 206 from its surroundings. Ideally, the outer shell of roadside sensor 206 can be made of a high-reflective material such as metal or glass. More specifically, the reflective index corresponding to the lidar wavelength of the outer shell of roadside sensor 206 can be higher than its surrounding objects (e.g., light post 208). This way, the segmentation of the point cloud for roadside sensor 206 from its surroundings can be relatively easy. Various techniques can be used for the segmentation task. In some embodiments, a deep-learning neural network can be trained to perform the segmentation task.

In most cases, the dimensions and shape of roadside sensor 206 are known. Therefore, one can determine the pose of roadside sensor 206 in the local reference coordinate system by comparing the segmented 3D point cloud of roadside sensor 206 with its known dimensions and shape. For example, the accurate pose of roadside sensor 206 in the local reference coordinate system can be determined by matching points in the 3D point cloud to surface points of a known computer-aided design (CAD) model of roadside sensor 206. In another example, a 3D scan of roadside sensor 206 can be performed before it is installed to generate a known 3D model (e.g., a point cloud) of roadside sensor 206.

As discussed previously, the local reference coordinate system can be the lidar-based coordinate system that corresponds to the pose of portable lidar unit 204 at the time instance it captures a certain frame (e.g., the first frame). In some embodiments, portable lidar unit 204 can be associated with a number of position sensors, including but not limited to an RTK GPS, an IMU, a rotary encoder, etc. For example, one or more position sensors can be integrated into portable lidar unit 204, or they can be included in the same enclosure with their relative positions/orientations predetermined. The pose of portable lidar unit 204 in the road-based coordinate system at a particular time instant can be determined based on data from the various position sensors at that time instant. For example, given a particular time instant (e.g., the instant it captures the first frame), the RTK GPS in portable lidar unit 204 can provide precise geographic location information, and the IMU or rotary encoder can provide information regarding the orientation of portable lidar unit 204.

Once the pose of portable lidar unit 204 is determined, a transformation matrix between the lidar-based coordinate system and the road-based coordinate system can be computed to transform the pose of roadside sensor 206 from the local reference coordinate system to the road-based coordinate system. Therefore, the extrinsic parameters of roadside sensor 206 with respect to the road-based coordinate system can be obtained, and the calibration of roadside sensor 206 is completed.

In the example shown in FIG. 2, portable lidar unit 204 is held by user 202. User 202 can walk around an intersection where one or more roadside sensors are located and use portable lidar unit 204 to scan the roadside sensors and their surroundings. In practice, it is also possible to mount a lidar unit on a vehicle (e.g., a specially designed data-collection vehicle). As the vehicle drives through the intersection, the lidar unit can scan the roadside sensors and their surroundings. When there are multiple to-be-calibrated roadside sensors in an intersection, it is preferable that the lidar scan (which can generate a continuous stream of lidar frames) cover the outer surface of all sensors. In addition, at any given time instant, the lidar frame should include at least two reference objects (e.g., a post and a cantilever attached to the post) along with the ground, thus allowing efficient and accurate alignment and stitching of point clouds from different lidar frames. The pose of each individual roadside sensor can then be determined based on the corresponding point cloud. For example, after the alignment of all lidar frames in a stream, the point cloud of each roadside sensor can be segmented to distinguish it from the background. The point cloud of a particular sensor can then be compared with its known shape and dimensions (or a known CAD or pre-scanned model) to obtain the pose of the particular sensor with respect to the local reference coordinate system.

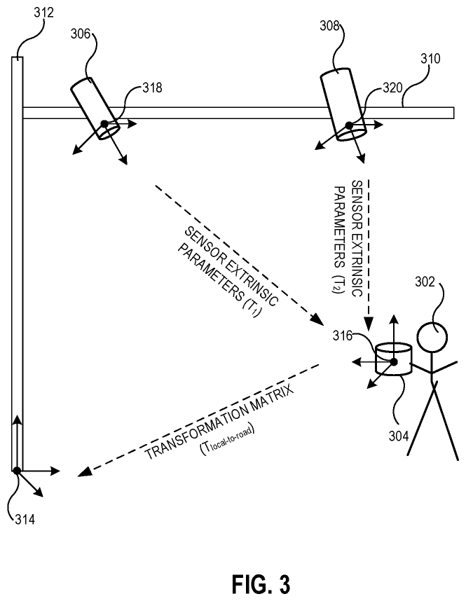

FIG. 3 illustrates an exemplary scenario for calibrating multiple roadside sensors, according to one embodiment of the instant application. In FIG. 3, a user 302 carrying a portable lidar unit 304 is approaching a sensor installation site (e.g., an intersection) with roadside sensors 306 and 308 mounted on a cantilever 310 attached to a light post 312. Roadside sensors 306 and 308 can be any type of sensor that can collect traffic data, including but not limited to visible-light cameras, infrared cameras, radars, lidar units, Global Positioning System (GPS) sensors, Inertial Measurement Unit (IMU) modules, sound sensors, etc.

While at the intersection, user 302 can aim portable lidar unit 304 at roadside sensors 306 and 308 to capture a stream of lidar frames. To calibrate all sensors in the intersection, portable lidar unit 304 should scan the outer surfaces of all sensors to include all sensors in the stream of lidar frames. More specifically, while performing the scan, user 302 should make sure that the laser beam(s) within portable lidar unit 304 can be shone upon as much outer surface of each sensor as possible. Moreover, to facilitate accurate frame alignment, each lidar scan (or frame) should include at least two reference objects and the ground. In the example shown in FIG. 3, each lidar frame should include both light post 312 and cantilever 310.

FIG. 3 also shows the various coordinate systems involved in multi-sensor data collection, including a road-based coordinate system 314, a lidar-based coordinate system 316, a first roadside-sensor-based coordinate system 318 (which is based on roadside sensor 306), and a second roadside-sensor-based coordinate system 320 (which is based on roadside sensor 308). In this example, the origin of road-based coordinate system 314 can be placed at the base of light post 312. In one example, the x-y plane of road-based coordinate system 314 can be the road surface with the x-axis along the road direction. The z-axis can point up from the ground. The origin of lidar-based coordinate system 316 can be anchored at a fixed point (e.g., the optical center) on portable lidar unit 304, and the z-axis can be along the optical axis of portable lidar unit 304. Similarly, the origin of a roadside-sensor-based coordinate system (e.g., coordinate system 318 or 320) can be anchored at a fixed point on the corresponding roadside sensor, and the z-axis can be along the optical axis of the corresponding roadside sensor.

Road-based coordinate system 314 can be an absolute, time-invariant coordinate system, and all sensor data should be converted into road-based coordinate system 314 such that they can be combined or fused. Because the pose of each roadside sensor remains unchanged with respect to road-based coordinate system 314, the roadside-sensor-based coordinate systems are also considered as time-invariant coordinate systems. Data collected by each roadside sensor (e.g., distance vectors) are represented according to the corresponding coordinate system. For example, data collected by roadside sensor 306 can be represented using values within coordinate system 318, and data collected by roadside sensor 308 can be represented using values within coordinate system 320.

On the other hand, lidar-based coordinate system 316 can be dynamic with respect to road-based coordinate system 314, as the pose of portable lidar unit 304 changes when it scans roadside sensors 306 and 308 from different angles. In some embodiments, a local reference coordinate system can be defined based on lidar-based coordinate system 316. In one example, the local reference coordinate system can be defined based on an initial pose (or the pose when it captures the first frame) of portable lidar unit 304 with respect to road-based coordinate system 314. Because the local reference coordinate system is defined based on the pose of portable lidar unit 304 at a particular time instant, it is also time-invariant with respect to road-based coordinate system 314. For simplicity of illustration, lidar-based coordinate system 316 in FIG. 3 can also represent the local reference coordinate system.

Converting data collected by a roadside sensor to road-based coordinate system 314 often requires the knowledge of the extrinsic parameters (or pose) of the roadside sensor with respect to road-based coordinate system 314. However, such knowledge is not readily available. In some embodiments, one can first determine the extrinsic parameters of a roadside sensor with respect to local reference coordinate system 316. To do so, lidar frames that contain the roadside sensor and are captured by portable lidar unit 304 can be aligned according to local reference coordinate system 316 to obtain a high-density point cloud of the scene. Subsequently, the point cloud corresponding to the particular roadside sensor can be segmented, and the local pose (i.e., the pose with respect to local reference coordinate system 316) of the roadside sensor can be determined based on the segmented point cloud. The extrinsic parameters of the roadside sensor with respect to the local reference coordinate system (or the local extrinsic parameters) can be denoted T_{sensor-to-local}. In the example shown in FIG. 3, the local extrinsic parameters of roadside sensor 306 are denoted T₁, and the local extrinsic parameters of roadside sensor 308 are denoted T₂.

A transformation matrix between local reference coordinate system 316 and road-based coordinate system 314 can be derived based on the spatial relationship between portable lidar 304 and the road. Note that portable lidar unit 304 can be equipped with a number of position sensors, such as an RTK GPS, an IMU, a rotary encoder, etc. The pose of portable lidar unit 304 with respect to road-based coordinate system 314 can be determined based on the outputs of those position sensors. In one example, local reference coordinate system 316 corresponds to the initial pose of portable lidar unit 304, which can be determined based on the output of the position sensors at the corresponding time instant. For example, those position sensors can provide the exact location of a predetermined point on portable lidar unit 394, which can be the origin of local reference coordinate system 316. Given the initial pose of portable lidar unit 304, the transformation matrix (denoted T_{local-to-road}) between local reference coordinate system 316 and road-based coordinate system 314 can be computed. Given the transformation matrix, a vector in the local reference coordinate system (denoted \vec{V}_{local}) can be converted to a vector in the road-based coordinate system (denoted \vec{V}_{road}) according to \vec{V}_{road}=T_{local-to-road}\vec{V}_{local}.

The pose (or the extrinsic parameters) of a roadside sensor with respect to road-based coordinate system 314 can then be computed based on the transformation matrix T_{local-to-road} More specifically, the extrinsic parameters of a roadside sensor can be computed as Tₛₑₙₛₒᵣ=T_{sensor-to-local}×T_{local-to-road}. In the example shown in FIG. 3, the sensor-to-local extrinsic parameters of roadside sensor 306 can be computed as T₁×T_{local-to-sensor}, and the extrinsic parameters of roadside sensor 306 can be computed as T₂×T_{local-to-sensor}.

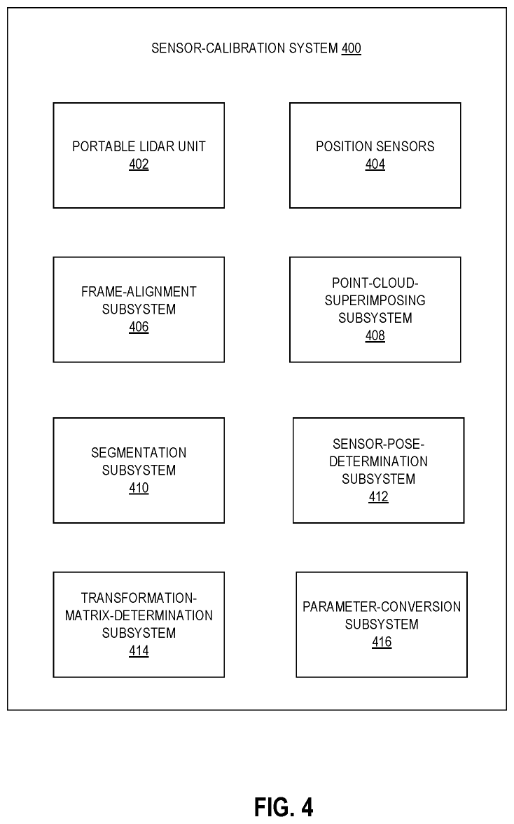

FIG. 4 illustrates an exemplary block diagram of a sensor-calibration system, according to one embodiment of the instant application. Sensor-calibration system 400 can include a portable lidar unit 402, a number of position sensors 404, a frame-alignment subsystem 406, a point-cloud-superimposing subsystem 408, a segmentation subsystem 410, a sensor-pose-determination subsystem 412, a transformation-matrix-determination subsystem 414, and a parameter-conversion subsystem 416.

Portable lidar unit 402 can be carried by a human user or a data-collection vehicle. Portable lidar unit 402 can be configured to scan a scene (e.g., an intersection) comprising one or more roadside sensors. More specifically, portable lidar unit 402 can be configured to scan the scene from different angles to ensure that the outer surface of each roadside sensor can be sufficiently covered by the scans. For higher-up sensors (e.g., sensors mounted on top of a light post), portable lidar unit 402 may not be able to scan the entire outer surface of a sensor but should scan as much surface area as possible.

Position sensors 404 can include but are not limited to an RTK GPS, an IMU, a rotary encoder, etc. Position sensors 404 can provide precise pose information (e.g., location and orientation) about portable lidar unit 402. For example, the RTK GPS can provide location information, and the IMU can provide orientation information. In some embodiments, position sensors 404 can be integrated within portable lidar unit 402. In some embodiments, position sensors 404 can be standalone sensors placed within the same physical enclosure with portable lidar unit 402.

Frame-alignment subsystem 406 can be responsible for aligning the frames in the stream of frames captured by portable lidar unit 402 to allow the superimposition of point clouds in the frames. In some embodiments, frame-alignment subsystem 406 can apply the ICP algorithm to align the frames. In one example, one can use the ICP algorithm to align two adjacent claims. More specifically, starting from the last frame, the frames in the stream can be aligned one by one until all frames are aligned according to the first frame. Including reference objects with distinctive features (e.g., post 312 and cantilever 310 shown in FIG. 3) and the ground can increase the accuracy in frame alignment. In alternative embodiments, frame-alignment subsystem 406 can align the frames according to a local reference coordinate system. The local reference coordinate system can be determined based on the pose of portable lidar unit 402 at a predetermined time instant (e.g., the time instant it captures the first frame). To improve the alignment efficiency, in some embodiments, before aligning the frames, frame-alignment subsystem 406 can remove transitory objects (e.g., vehicles or pedestrians) from each frame.

Point-cloud-superimposing subsystem 408 can be responsible for superimposing the point clouds from the aligned frames to obtain a large high-density point cloud. For a large installation site with many roadside sensors at different locations, superimposing the frames can also include stitching the frames into a wide-view frame. Segmentation subsystem 410 can be responsible for segmenting the point cloud of each roadside sensor in the large frame. In some embodiments, segmentation subsystem 410 can apply a machine learning technique (e.g., by training a deep learning neural network) to perform the segmentation task. To ensure segmentation accuracy, the outer surface or cover of the roadside sensors can be made of a high-reflective material (e.g., metal or glass).

Sensor-pose-determination subsystem 412 can be responsible for determining the pose of each roadside sensor based on a corresponding segmented point cloud. In some embodiments, determining the pose of a roadside sensor can also include comparing the 3D point cloud of the roadside sensor with its known 3D CAD model or 3D point cloud obtained by scanning the sensor prior to its installation (referred to as a pre-scanned point cloud). For example, the pose of the CAD model can be manipulated to find a match between surface points on the CAD model and the segmented 3D point cloud. Similarly, the pose of the pre-scanned point cloud can be manipulated to match the pose of the segmented point cloud. The determined pose of the roadside sensor is with respect to the local reference coordinate system.

Transformation-matrix-determination subsystem 414 can be responsible for determining the transformation matrix between two coordinate systems. In some embodiments, transformation-matrix-determination subsystem 414 can compute a transformation matrix between the road-based coordinate system and the local reference coordinate system (i.e., T_{local-to-road}) based on the corresponding instant pose of the portable lidar in the road-based coordinate system. Note that the instant pose of the portable lidar can be determined based on the output from one or more position sensors associated with the portable lidar. Parameter-conversion subsystem 416 can be responsible for converting the extrinsic parameters (i.e., pose) of each roadside sensor from the local reference coordinate system to the roadside reference system based on a corresponding transformation matrix T_{local-to-road}. In some embodiments, the extrinsic parameters of a roadside sensor can be converted to the road-based coordinate system according to: Tₛₑₙₛₒᵣ=T_{sensor-to-local}×T_{local-to-road}.

The various subsystems included in FIG. 4 (e.g., subsystems 406-416) can include any combination of hardware and software modules. In addition, the various subsystems can be integrated within the same computing entity (e.g., a standalone computer or a server) or can be distributed among multiple computing entities (e.g., multiple servers). In one example, the lidar frames can be sent to one computer for frame alignment and superimposing, and the point cloud segmentation can be performed by a different computer. When the portable lidar unit is carried by a data-collection vehicle, a computer installed on the data-collection vehicle can include all subsystems (e.g., subsystems 406-416) needed for the sensor calibration.

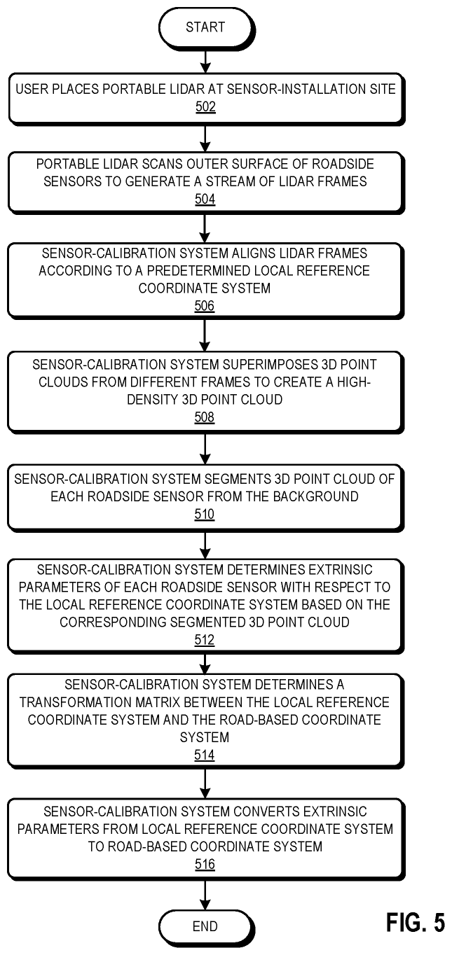

FIG. 5 presents a flowchart illustrating an exemplary sensor-calibration process, according to one embodiment of the instant application. In one or more embodiments, one or more of the steps in FIG. 5 may be repeated and/or performed in a different order. Accordingly, the specific arrangement of steps shown in FIG. 5 should not be construed as limiting the scope of the technique.

During operation, a user can place a portable lidar at a sensor installation site (operation 502). One or more roadside sensors can be installed at the sensor installation site. In some examples, roadside sensors can be installed at an intersection. In different examples, roadside sensors can be installed along a stretch of a road. The portable lidar unit can be handheld and carried by a human user who is on foot, or it can be an on-vehicle unit mounted on a data-collection vehicle parked or driven near the roadside sensors.

The portable lidar can scan the outer surface of the roadside sensors to generate a stream of lidar frames (operation 504). To calibrate all roadside sensors in a particular installation site (e.g., an intersection or a stretch of a road), the portable lidar unit should scan all sensors and their surroundings. To ensure that a point cloud representing a roadside sensor can have a sufficient number of points, the portable lidar unit can scan the outer surface of the roadside sensor multiple times from different angles. Moreover, to facilitate subsequent frame alignment, in each scan or lidar frame, the portable lidar unit should capture at least two reference objects with large easy-to-recognize features. Examples of reference objects can include light posts, utility posts, cantilevers, etc.

The sensor-calibration system can align the lidar frames according to a predetermined local reference coordinate system (operation 506). Various techniques can be applied. In one embodiment, the system can apply an ICP algorithm to align frames in different coordinate systems. In an alternative embodiment, the spatial relationship between different coordinate systems can be determined based on the output of position sensors associated with the portable lidar unit, and frames in the different coordinate systems can be aligned based on the determined spatial relationship. In some embodiments, transitory objects (e.g., vehicles or pedestrians) can be removed from the lidar frames to improve the alignment efficiency.

Subsequent to aligning the frames according to the local reference coordinate system, the sensor-calibration system can superimpose the 3D point clouds from the different frames to create a high-density 3D point cloud (operation 508). The high-density 3D point cloud can represent the sensor installation site comprising the multiple roadside sensors. Data for the high-density point cloud is represented with respect to the local reference coordinate system. The sensor-calibration system can segment the 3D point cloud of each roadside sensor from the background (operation 510). In some embodiments, multiple roadside sensors can be segmented simultaneously. A machine learning based approach (e.g., a deep-learning neural network) can be used to perform point-cloud segmentation.

The sensor-calibration system can then determine the extrinsic parameters (or pose) of each roadside sensor with respect to the local reference coordinate system based on the corresponding segmented 3D point cloud (operation 512). In some embodiments, the 3D point cloud of a roadside sensor can be compared to its known shape and dimensions or known 3D models. In one example, the pose of a 3D CAD model of the roadside sensor can be manipulated to find a match between the surface points of the CAD model and points within the 3D point cloud. In another example, the pose of a pre-scanned point cloud of the roadside sensor can be manipulated to match the pose of the segmented 3D point cloud. The pose information includes both the position and orientation of the roadside sensor. Accordingly, the extrinsic parameters associated with each roadside sensor can be determined. Note that the extrinsic parameters can include a rotation vector \vec{R} and a translation vector \vec{t}, and both rotation and translation vectors are with respect to the local reference coordinate system.

The sensor-calibration system can also determine a transformation matrix between the local reference coordinate system and the road-based coordinate system (operation 514). In some embodiments, the transformation matrix can be determined based on the measured pose of the portable lidar unit. The sensor-calibration system converts the extrinsic parameters (e.g., rotation and translation vectors) from the local reference system to the road-based coordinate system (operation 516). More specifically, the extrinsic parameters of each roadside sensor with respect to the local reference coordinate system can be converted to parameters with respect to the road-based coordinate system, thus completing the calibration process of the roadside sensors. The extrinsic parameters of each roadside sensor with respect to the road-based coordinate system can be output as the calibration result. The portable lidar unit can also be transported to the next sensor installation site to calibrate sensors there.

Compared with existing approaches to calibrating roadside sensors, the proposed solution does not require prior knowledge (e.g., location or orientation) of the roadside sensors and specialized equipment. Moreover, the calibration process will not cause interruption to traffic and can be performed by human operators in a relatively safe manner. To calibrate roadside sensors mounted high above, there is no need for a worker to stand on a high-elevation construction lift to perform manual calibration. Moreover, when there are multiple roadside sensors installed near each other, the multiple sensors can be calibrated simultaneously.

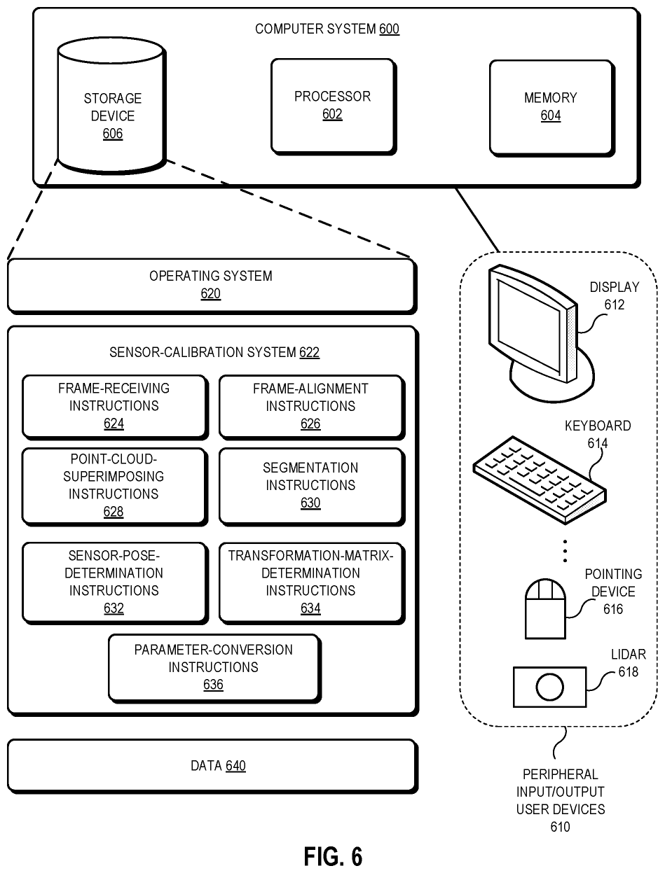

FIG. 6 illustrates an exemplary computer system that facilitates the sensor calibration operation, according to one embodiment of the instant application. Computer system 600 includes a processor 602, a memory 604, and a storage device 606. Furthermore, computer system 600 can be coupled to peripheral input/output (I/O) user devices 610, e.g., a display device 612, a keyboard 614, a pointing device 616, and a portable lidar 618. Storage device 606 can store an operating system 620, a sensor-calibration system 622, and data 640. In some embodiments, computer system 600 can be implemented as part of the data-collection system for autonomous driving.

Sensor-calibration system 622 can include instructions, which when executed by computer system 600, can cause computer system 600 or processor 602 to perform methods and/or processes described in this disclosure. Specifically, sensor-calibration system 622 can include instructions for receiving a stream of frames collected by a portable lidar unit (frame-receiving instructions 624), instructions for aligning the lidar frames (frame-alignment instructions 626), instructions for superimposing point clouds in the aligned frames (point-cloud-superimposing instructions 628), instructions for segmenting point clouds corresponding to road-side sensors (segmentation instructions 630), instructions for determining the pose (or extrinsic parameters) of each roadside sensor with respect to a local reference coordination system (sensor-pose-determination instructions 632), instructions for determining a transformation matrix between the local reference coordinate system and the road-based coordinate system (transformation-matrix-determination instructions 634), and instructions for converting the extrinsic parameters of each roadside sensor from the local reference coordinate system to the road-based coordinate system (parameter-conversion instructions 636). Data 640 can include shape and dimension information about the roadside sensors.

This disclosure presents a solution to the problem associated with calibrating a large number of roadside sensors. The solution allows simultaneous calibration of multiple roadside sensors installed in the same site (e.g., a traffic intersection or a stretch of a road). To calibrate the sensors, a portable lidar unit can be brought to the sensor installation site to scan the multiple roadside sensors and generate a stream of frames. The frames can be aligned in the spatial domain according to a local reference coordinate system, and the aligned frames can be superimposed to generate a large high-density 3D point cloud. The 3D point cloud of each roadside sensor can be segmented from the large high-density 3D point cloud. The pose (or extrinsic parameters) of a to-be-calibrated roadside sensor with respect to a local reference coordinate system can be determined based on the corresponding segmented 3D point cloud. A transformation matrix between the local reference coordinate system and a road-based coordinate system can be computed, and the extrinsic parameters of the to-be-calibrated roadside sensor can be converted into the road-based coordinate system and outputted as the calibration result.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the optimized parameters from the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method for calibrating extrinsic parameters of roadside sensors for autonomous driving, the method comprising:
placing a portable light-detection-and-ranging (lidar) unit at a sensor-installation site comprising one or more to-be-calibrated roadside sensors;
scanning, by the portable lidar unit, outer surfaces of the to-be-calibrated roadside sensors from different angles to generate a stream of frames;
aligning, spatially, the stream of frames based on a local reference coordinate system;
superimposing the aligned frames;
segmenting, from the superimposed frames, a point cloud associated with a to-be-calibrated roadside sensor;
determining extrinsic parameters of the to-be-calibrated roadside sensor with respect to the local reference coordinate system based on the segmented point cloud; and
converting the extrinsic parameters from the local reference coordinate system to a road-based coordinate system.

2. The method of claim 1, wherein aligning the stream of frames comprises applying an Iterative Closest Point (ICP) algorithm.

3. The method of claim 1,
wherein the portable lidar unit further comprises one or more position sensors; and
wherein aligning the stream of frames comprises determining an instant pose of the portable lidar unit associated with each frame of the stream of frames based on measurements of the position sensors.

4. The method of claim 3, wherein the local reference coordinate system is determined based on the instant pose of the portable lidar unit associated with a first frame of the stream of frames.

5. The method of claim 3, wherein the position sensors comprise one or more of:
a Global Positioning System (GPS) sensor;
an Inertial Measurement Unit (IMU); and
a rotary encoder.

6. The method of claim 1, further comprising determining a transformation matrix between the local reference coordinate system and road-based coordinate system.

7. The method of claim 6, wherein converting the extrinsic parameters from the local reference coordinate system to the road-based coordinate system comprises multiplying the extrinsic parameters with the transformation matrix.

8. The method of claim 1,
wherein the portable lidar unit is configured to scan, in each frame, at least two reference objects with distinctive features; and
wherein aligning, spatially, the stream of frames comprises aligning the reference objects.

9. The method of claim 1, wherein determining the extrinsic parameters of the to-be-calibrated roadside sensor comprises comparing the segmented point cloud with a computer-aided design (CAD) model of the roadside sensor or a point cloud of the roadside sensor obtained by scanning the roadside sensor prior to installation.

10. The method of claim 1, wherein aligning, spatially, the stream of frames further comprises removing transitory objects from each frame.

11. A system for calibrating extrinsic parameters of roadside sensors for autonomous driving, comprising:
a portable light-detection-and-ranging (lidar) unit to be brought to a sensor-installation site comprising one or more to-be-calibrated roadside sensors, wherein the portable lidar is configured to scan outer surfaces of the to-be-calibrated roadside sensors from different angles to generate a stream of frames;
a frame-alignment subsystem configured to align, spatially, the stream of frames based on a local reference coordinate system;
a frame-superimposing subsystem configured to superimpose the aligned frames;
a segmentation subsystem configured to segment, from the superimposed frames, a point cloud associated with a to-be-calibrated roadside sensor;
a sensor-pose determination subsystem to determine extrinsic parameters of the to-be-calibrated roadside sensor with respect to the local reference coordinate system based on the segmented point cloud; and
a parameter-conversion subsystem to convert the extrinsic parameters from the local reference coordinate system to a road-based coordinate system.

12. The system of claim 11, wherein the frame-alignment subsystem is to apply an Iterative Closest Point (ICP) algorithm to align the stream of frames.

13. The system of claim 11,
wherein the portable lidar unit further comprises one or more position sensors; and
wherein the frame-alignment subsystem is to determine an instant pose of the portable lidar unit associated with each frame of the stream of frames based on measurements of the position sensors.

14. The system of claim 13, wherein the local reference coordinate system is determined based on the instant pose of the portable lidar unit associated with a first 2 frame of the stream of frames.

15. The system of claim 13, wherein the position sensors comprise one or more of:
a Global Positioning System (GPS) sensor;
an Inertial Measurement Unit (IMU); and
a rotary encoder.

16. The system of claim 11, further comprising a transformation-matrix-determination subsystem to determine a transformation matrix between the local reference coordinate system and road-based coordinate system.

17. The system of claim 16, wherein the parameter-conversion subsystem is to convert the extrinsic parameters from the local reference coordinate system to the road-based coordinate system by multiplying the extrinsic parameters with the transformation matrix.

18. The system of claim 11,
wherein the portable lidar unit is configured to scan, in each frame, at least two reference objects with distinctive features; and
wherein the frame-alignment subsystem is to align the reference objects while aligning the stream of frames comprises aligning.

19. The system of claim 11, wherein the sensor-pose determination subsystem is to determine the extrinsic parameters of the to-be-calibrated roadside sensor by comparing the segmented point cloud with a computer-aided design (CAD) model of the roadside sensor or a point cloud of the roadside sensor obtained by scanning the roadside sensor prior to installation.

20. The system of claim 11, wherein, while aligning the stream of frames, the frame-alignment subsystem is to remove transitory objects from each frame.
